(19) United States
(12) Patent Application Publication
(10) Pub. No.: US 2011/0157155 A1
(43) Pub. Date: Jun. 30, 2011

(54) LAYER MANAGEMENT SYSTEM FOR CHOREOGRAPHING STEREOSCOPIC DEPTH

(75) Inventors: Tara Handy Turner, Marina Del Rey, CA (US); Matthew F. Schnittker, Castaic, CA (US); Robert M. Neuman, Santa Clarita, CA (US); Evan M. Goldberg, Los Angeles, CA (US); Joseph W. Longson, Castaic, CA (US)

(73) Assignee: Disney Enterprises, Inc., Burbank, CA (US)

(21) Appl. No.: 12/650,800

(22) Filed: Dec. 31, 2009

(51) Int. Cl. G06T 15/00; G09G 5/00

(52) U.S. Cl. 345/419; 345/619

(57) ABSTRACT

Implementations of the present disclosure include an interface that provides display and management of depth and volume information for a stereoscopic 3-D image. More particularly, the interface provides information for the one or more layers that comprise the stereoscopic 3-D image. Depth information for the one or more layers of the stereoscopic image may include aspects of a pixel offset, z-axis position and virtual camera positions. The adjustment of one aspect of the depth information may affect the values for the other aspects of depth information for the layers. This information may be used by an animator to confirm the proper alignment of the objects and layers of the image in relation to the image as a whole. In addition, the interface may maintain such depth information for several stereoscopic 3-D images such that the information and adjustment to any number of 3-D images may be obtained through the interface.

### FIELD OF THE INVENTION

Aspects of the present invention relate to conversion of two dimensional (2-D) multimedia content to stereoscopic three dimensional (3-D) multimedia content. More particularly, aspects of the present invention involve an apparatus and method for displaying pertinent depth and volume information for one or more stereoscopic 3-D images and for choreographing stereoscopic depth information between the one or more stereoscopic 3-D images.

### BACKGROUND

Three dimensional (3-D) imaging, or stereoscopy, is a technique used to create the illusion of depth in an image. In many cases, the stereoscopic effect of an image is created by providing a slightly different perspective of a particular image to each eye of a viewer. The slightly different left eye image and right eye image may present two perspectives of the same object, where the perspectives differ from each other in a manner similar to the perspectives that the viewer's eyes may naturally experience when directly viewing a three dimensional scene. For example, in a frame of a stereoscopic 3-D film or video, a corresponding left eye frame intended for the viewer's left eye may be filmed from a slightly different angle (representing a first perspective of the object) from the corresponding right eye frame intended for the viewer's right eye (representing a second perspective of the object). When the two frames are viewed simultaneously or nearly simultaneously, the difference between the left eye frame and the right eye frame provides a perceived depth to the objects in the frames, thereby presenting the combined frames in what appears as three dimensions.

In creating stereoscopic 3-D animation from 2-D animation, one approach to construct the left eye and right eye images necessary for a stereoscopic 3-D effect is to first create a virtual 3-D environment consisting of a computer-based virtual model of the 2-D image, which may or may not include unique virtual models of specific objects in the image. These objects are positioned and animated in the virtual 3-D environment to match the position of the object(s) in the 2-D image when viewed through a virtual camera. For stereoscopic rendering, two virtual cameras are positioned with an offset between them (inter-axial) to simulate the left eye and right eye views of the viewer. Once positioned, the color information from each object in the original image is “cut out” (if necessary) and projected from a virtual projecting camera onto the virtual model of that object. This process is commonly referred to as projection mapping. The color information, when projected in this manner, presents itself along the front (camera facing) side of the object and also wraps around some portion of the front sides of the object. Specifically, any pixel position where the virtual model is visible to the projection camera will display a color that matches the color of the projected 2-D image at that pixel location. Depending on the algorithm used, there may be some stretching or streaking of the pixel color as a virtual model bends toward or away from the camera at extreme angles from perpendicular, but this is generally not perceived by a virtual camera positioned with sufficiently small offset to either side of the projecting camera.

Using this projection-mapped model in the virtual 3-D environment, the left eye and right eye virtual cameras will capture different perspectives of particular objects (representing the left eye and the right eye views) that can be rendered to generate left eye and right eye images for stereoscopic viewing. However, this technique to convert a 2-D image to a stereoscopic 3-D image has several drawbacks. First, creating a virtual 3-D environment with virtual models and cameras is a labor-intensive task requiring computer graphics software and artistic and/or technical talent specialized in the field of 3-D computer graphics. Second, with animated objects, the virtual model must alter over time (frame by frame) to match the movement and deformation of the object in the 2-D image. For the best results, the alteration of the model precisely matches the movement of the object(s) frame by frame. Camera movement may also be taken into account. This is a time consuming task requiring advanced tracking and significant manual labor. In addition, this requires that the 2-D image be recreated almost entirely in a virtual 3-D environment, which also requires significant manual labor, as it implies effectively recreating the entire movie with 3-D objects, backgrounds and cameras.

### SUMMARY

One implementation of the present disclosure may take the form of a system for visualization and editing of a stereoscopic frame. The system comprises one or more computing devices in communication with a display. The computing devices are coupled with a storage medium storing one or more stereoscopic images including depth and volume information for the at least one layer. The system may also include a visualization and editing interface stored on the storage medium and displayed on the display configured to provide at least one depth module that provides for viewing of the depth and volume information for the layer and provide at least one editing control that provides for editing of the depth and volume information for the at least one layer.

Another implementation of the present disclosure may take the form of a machine-readable storage medium configured to store a machine-executable code that, when executed by a computer, causes the computer to perform the operation of displaying a user interface comprising at least one depth module that provides for the viewing of depth and volume information for the stereoscopic frame. The depth and volume information includes at least a horizontal offset value of at least one pixel of the at least one layer relative to a corresponding pixel of a duplicate version of the at least one layer and a corresponding perceptual z-axis position of the at least one pixel in the stereoscopic image when viewed stereoscopically. The machine-executable code also causes the computer to perform the operation of providing for editing of the stereoscopic frame through an edit control of the user interface.

Still another implementation of the present disclosure may take the form of a method for editing a stereoscopic frame. The method may comprise the operations of displaying a user interface comprising at least one depth module that provides for the viewing of depth and volume information of a stereoscopic frame. The depth and volume information may include at least a horizontal offset value of at least one pixel of the stereoscopic frame relative to a corresponding pixel of a duplicate version of the stereoscopic frame, such that the stereoscopic frame and the duplicate stereoscopic frame are displayed substantially contemporaneously for stereoscopic viewing of the stereoscopic frame. The method may also include the operations of receiving a user input through the user interface indicating an edit to the depth and volume information and horizontally offsetting, in response to the user input, the at least one pixel of the stereoscopic frame relative to the corresponding pixel of the duplicate version of the stereoscopic frame.

### BRIEF DESCRIPTION OF THE DRAWINGS

FIG. 1 is a flowchart of a method for converting a 2-D image to a stereoscopic 3-D image by extracting one or more object layers of the 2-D image and applying a pixel offset to each layer.

FIG. 2 is a diagram illustrating a plurality of layers of an image of an animated multimedia presentation.

FIG. 3 is a diagram illustrating the position of several layers of a stereoscopic 3-D frame along a perceptual z-axis of the stereoscopic 3-D frame.

FIG. 4 is a diagram illustrating the creation of corresponding left eye and right eye image layers from a 2-D image layer, with both image layers shifted such that the total pixel shift of the image layers equals a determined pixel offset.

FIG. 5 is a diagram illustrating a user interface displaying depth and volume information for one or more layers of a stereoscopic 3-D frame or frames and for choreographing stereoscopic depth information between the layers and stereoscopic 3-D frames.

FIG. 6 is a diagram illustrating a navigation and scene information module of the user interface displaying scene information of a stereoscopic 3-D frame.

FIG. 7 is a diagram illustrating a layer depth information module of the user interface displaying depth information for one or more layers of a stereoscopic 3-D frame.

FIG. 8 is a top-down view of a virtual camera and several points either within or outside the viewing area.

FIG. 9 is a top-down view of the projection of a stereoscopic 3-D frame onto a 2-D screen plane.

FIG. 10 is a top-down view of the projected position of several points within a stereoscopic 3-D frame on a 2-D screen plane.

FIG. 11 is a top-down view of the projection of the x-offset for a left and right camera to create a stereoscopic 3-D frame.

FIG. 12 is a diagram illustrating a scene information module of the user interface displaying information of a frame of a stereoscopic 3-D multimedia presentation.

FIG. 13 is a diagram illustrating a virtual camera module of the user interface displaying depth information for one or more virtual cameras of a stereoscopic 3-D frame.

FIG. 14 is a diagram illustrating a virtual two camera system obtaining the left eye and right layers to construct a stereoscopic 3-D frame.

FIG. 15 is a diagram illustrating a floating window module of the user interface displaying eye boundary information of a stereoscopic 3-D frame.

FIG. 16 is a diagram illustrating an advanced camera control module of the user interface allowing a user of the interface to edit one or more virtual camera settings and layer depth information of a stereoscopic 3-D frame.

FIG. 17 is a block diagram illustrating a particular system for converting a 2-D image of a multimedia presentation to a 3-D image and presenting a user interface for providing depth information of the stereoscopic 3-D image.

### DETAILED DESCRIPTION

Implementations of the present disclosure involve methods and systems for converting a 2-D multimedia image to a stereoscopic 3-D multimedia image by obtaining layer data for a 2-D image where each layer pertains to some image feature of the 2-D image, duplicating a given image feature or features and offsetting in the x-dimension one or both of the image features to create a stereo pair of the image feature. The layers may be reproduced as a corresponding left eye version of the layer and a corresponding right eye version of the layer. Further, the left eye layer and/or the right eye layer data is shifted by a pixel offset to achieve the desired 3-D effect for each layer of the image. Offsetting more or less of the x value of each pixel in an image feature of a layer creates more or less stereoscopic depth perception. Thus, when two copies of an image feature are displayed with the image feature pixel offset, with appropriate viewing mechanisms, the viewer perceives more or less stereo depth depending on the amount of pixel offset. This process may be applied to each frame of a animated feature film to convert the film from 2-D to 3-D.

In this manner, each layer, object, group of pixels or individual pixel of the stereoscopic 3-D image has an associated pixel offset or z-axis position that represents perceived depth of the layer within the corresponding 3-D stereoscopic image. However, maintaining depth information for each layer of a stereoscopic 3-D image, including the pixel offset and related z-axis position for each image of a multimedia film or series of images does not require the complex underlying software that is used to apply the process of generating the left and right images. Further, adjusting the perceived depth for any one layer of the stereoscopic 3-D image may affect the depth information for the other layers or adjacent images Thus, what is needed, among other things, is a method and apparatus for displaying pertinent depth and volume information for one or more stereoscopic 3-D images and for choreographing stereoscopic depth information between the one or more stereoscopic 3-D images.

Thus, implementations of the present disclosure include an interface that provides display and management of depth and volume information for a stereoscopic 3-D image. More particularly, the interface provides information for the one or more layers that comprise the stereoscopic 3-D image. Depth information for the one or more layers of the stereoscopic image may include aspects of a pixel offset, z-axis position and virtual camera positions. Further, the adjustment of one aspect of the depth information may affect the values for the other aspects of depth information for the layers. This information may be used by an animator or artist to confirm the proper alignment of the objects and layers of the image in relation to the image as a whole. Further, such information may be used by an artist or animator to provide more or less pixel offset to a layer or object of the stereoscopic 3-D image to adjust the perceived depth of the image. In addition, the interface may maintain such depth information for several stereoscopic 3-D images such that the information and adjustment to any number of 3-D images may be obtained through the interface.

For convenience, the embodiments described herein refer to a 2-D image as a “frame” or “2-D frame.” However, it should be appreciated that the methods and devices described herein may be used to convert any 2-D multimedia image into a stereoscopic 3-D image, such as 2-D multimedia images including a photo, a drawing, a computer file, a frame of a live action film, a frame of an animated film, a frame of a video or any other 2-D multimedia image. Further, the term “layer” as used herein indicates any portion of a 2-D frame, including any object, set of objects, or one or more portions of an object from a 2-D frame. Thus, the depth model effects described herein may be applied to any portion of a 2-D frame, irrespective of whether the effects are described with respect to layers, objects or pixels of the frame.

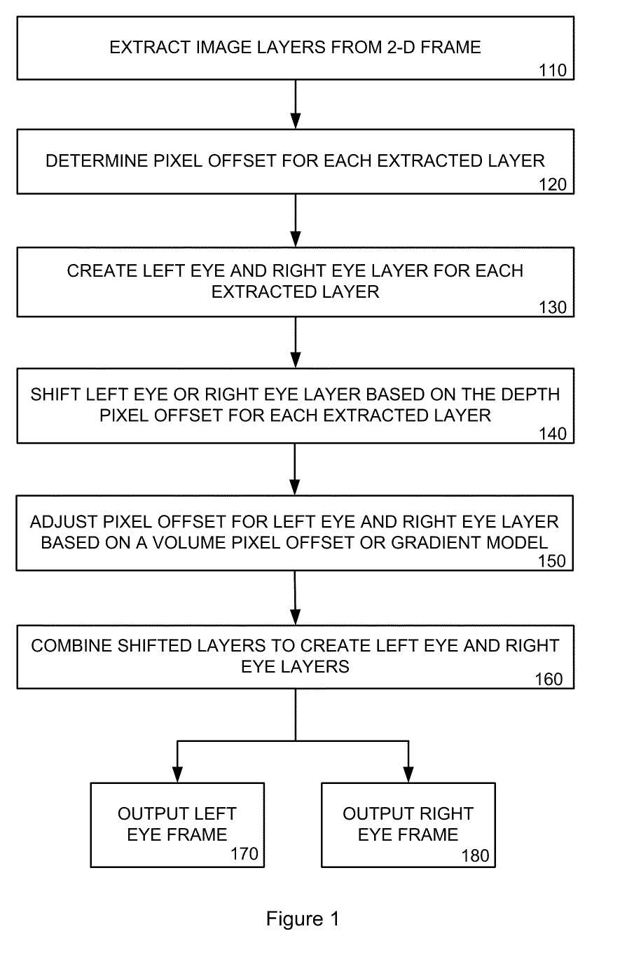

FIG. 1 is a flowchart of a method for converting a 2-D multimedia frame to a stereoscopic 3-D multimedia frame by utilizing layers of the 2-D frame. Several operations of the method are described in detail in related United States Patent Application titled “METHOD AND SYSTEM FOR UTILIZING PRE-EXISTING IMAGE LAYERS OF A TWO DIMENSIONAL IMAGE TO CREATE A STEREOSCOPIC IMAGE” by Tara Handy Turner et. al., U.S. application Ser. No. 12/571,407 filed Sep. 30, 2009, the contents of which are incorporated in their entirety by reference herein. By performing the following operations for each frame of a 2-D D animated film and combining the converted frames in sequence, the animated 2-D film may similarly be converted into a stereoscopic 3-D film. In one embodiment, the operations may be performed by one or more workstations or other computing systems to convert the 2-D frames into stereoscopic 3-D frames.

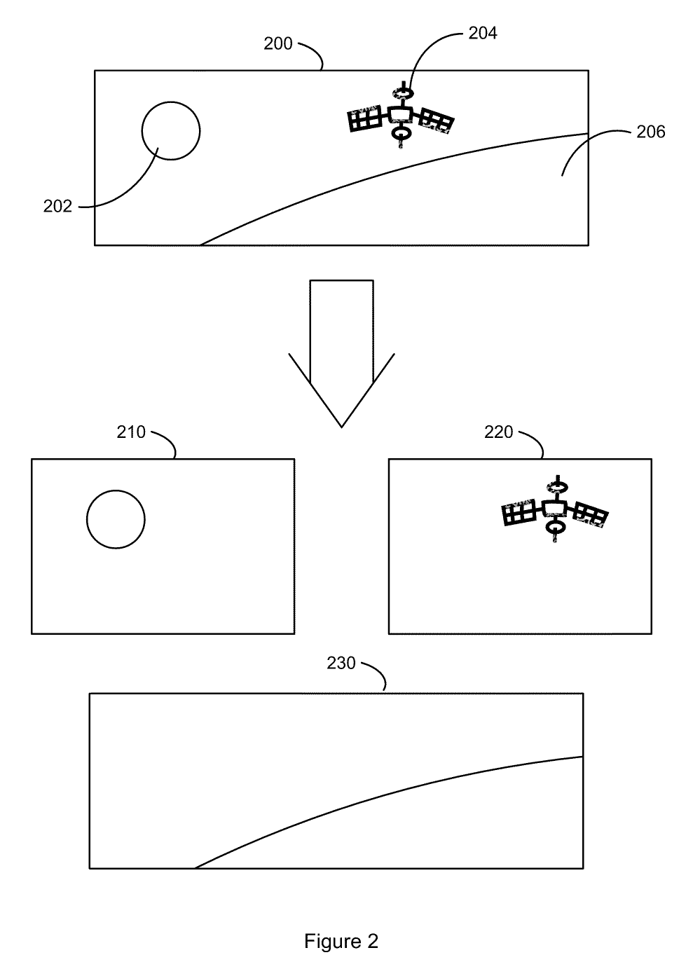

The method may begin in operation 110 where one or more layers are extracted from the 2-D frame by a computer system. A layer may comprise one or more portions of the 2-D frame. The example 2-D frame 200 of FIG. 2 illustrates a space scene including three objects; namely, a moon 202, a satellite 204 and a planet 206. Each of these objects are extracted from the 2-D image or otherwise provided as separate layers of the frame 200. The layers of the 2-D image 200 may include any portion of the 2-D image, such as an object, a portion of the object or a single pixel of the image. As used herein, a layer refers to a collection of data, such as pixel data, for a discrete portion of image data where the meaningful color data exists for the entirety of the image or, in some cases, for some area less than the entirety of image data. For example, if an image consists of a moon 202, satellite 204 and a planet 206, image data for the moon may be provided on a layer and image data for the satellite and planet may be provided on separate and distinct layers.

The layers can be extracted from the composite 2-D frame in several ways. For example, the content of each extracted layer can be digitally extracted from the 2-D frame by a computing system utilizing a rotoscoping tool or other computer image processing tool to digitally remove a given object(s) and insert a given object(s) into a distinct layer. In another example, the layers for a 2-D frame may be digitally stored separately in a computer-readable database. For example, distinct layers pertaining to each frame of a cell animated feature film may be digitally stored in a database, such as the Computer Animation Production System (CAPS) developed by the Walt Disney Company in the late 1980s.

The methods and systems provided herein describe several techniques and a user interface for segmenting a region of a 2-D frame or layer, as well as creating a corresponding matte of the region for the purpose of applying a pixel offset to the region. Generally, these techniques are utilized to segment regions of a layer such that certain 3-D effects may be applied to the region, separate from the rest of the layer. However, in some embodiments, the techniques may also be used to segment regions of a 2-D frame to create the one or more layers of the frame. In this embodiment, a region of the 2-D frame is segmented as described herein and stored as a separate file or layer of the 2-D frame in a computing system.

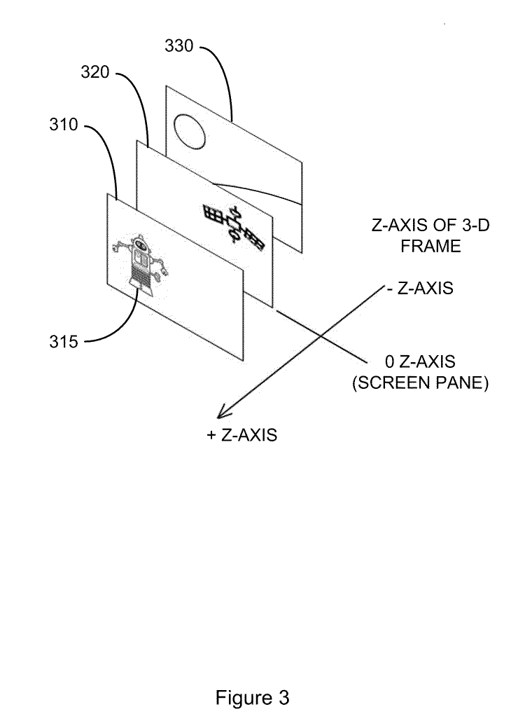

Upon extraction of a layer or otherwise obtaining layer pixel data, a user or the computing system may determine a pixel offset for the layer pixel data in operation 120. Each pixel, or more likely a collection of adjacent pixels, of the 2-D frame may have an associated pixel offset that determines the object's perceived depth in the corresponding stereoscopic 3-D frame. For example, FIG. 3 is a diagram illustrating the perceived position of several layers of a stereoscopic 3-D frame along a z-axis of the stereoscopic 3-D frame. As used herein, the z-axis of a stereoscopic 3-D frame or image represents the perceived position of a layer of the frame when viewed as a stereoscopic 3-D image. In one particular embodiment, any layer 310 of the stereoscopic 3-D frame appearing in the foreground of the frame has a corresponding positive z-axis position that indicates the position of the layer relative to the plane of the screen from which the stereoscopic 3-D frame is presented. Additionally, any layer 330 appearing in the background of the stereoscopic 3-D frame has a corresponding negative z-axis position while a layer 320 appearing on the plane of the screen may have a zero z-axis position. However, it should be appreciated that the layers of the frame are not physically located at a z-axis positions described herein. Rather, because the stereoscopic 3-D frame appears to have depth when viewed in stereoscopic 3-D, the z-axis position merely illustrates the perceived position of a layer relative to the screen plane of the stereoscopic 3-D frame. Though not a requirement, this position, and hence the screen plane in this example, very often corresponds to what is known as the point of convergence in a stereoscopic system. Further, it is not necessary that a positive z-axis position correspond to the layer appearing in the foreground of the stereoscopic 3-D frame and a negative z-axis position correspond to the layer appearing in the background. Rather, any value may correspond to the perceived position of the layer of the stereoscopic 3-D frame as desired. For example, in some computer systems, layers that are perceived in the background of the stereoscopic 3-D frame may have a positive z-axis position while those layers in the foreground have a negative z-axis position. In still another example, the zero z-axis position corresponds with the furthest perceived point in the background of the stereoscopic 3-D frame. Thus, in this example, every layer of the stereoscopic 3-D frame has a positive z-axis position relative to the furthest perceived point in the background. As used herein, however, a z-axis position value corresponds to the example shown in FIG. 3.

In the example of FIG. 3, each pixel of any particular layer of the 2-D frame has the same pixel offset. Thus, each object of the layer appears at the same z-axis position within the stereoscopic 3-D frame. Moreover, while each object, e.g. the moon 202, the satellite 204 and the planet 206, are given a z-axis depth, each object appears flat or with no volume. Stated differently, initially a pixel offset is applied uniformly to all pixels of a given object or layer. To provide a non-flat appearance of a given object and a more realistic stereoscopic 3-D effect, the pixel offset of one or more pixels of the layer is adjusted to add volume or a more detailed depth perception to the objects of the layer, or to otherwise provide non-uniformity to the object through variable pixel offsets.

For example, returning to FIG. 2, the moon 202 object has a round shape. While the stereoscopic depth of the moon layer 210 layer provides a stereoscopic depth as to the orientation of the moon in relation to the other shapes of the frame, the moon object itself still appears flat. Thus, to provide a volume stereoscopic 3-D effect to the moon 202 object, pixel offset for the pixels defining the moon object are adjusted such that the pixels of the moon are located either in the foreground or background of the stereoscopic 3-D frame in relation to the moon layer 210, or are not adjusted and are maintained at the moon layer, thereby providing the moon object with stereoscopic volume. Several techniques to apply volume to the layers of an frame are described in greater detail in related United States Patent application titled “METHOD AND SYSTEM FOR CREATING DEPTH AND VOLUME IN A 2-D PLANAR IMAGE” by Tara Handy Turner et. al., U.S. application Ser. No. 12/571,406 filed Sep. 30, 2009, the entirety of which is incorporated by reference herein. This volume process may be applied to any layer of the 2-D frame, including being applied to one or more objects of a particular layer. Thus, the volume applied to one object of a particular layer may differ from the volume applied to a separate object of the same layer. Generally, the stereoscopic volume may be applied individually to any aspect of the 2-D frame. Moreover, stereoscopic volume may be applied to any given object irrespective of its relation to a layer or any other object.

Additional stereoscopic techniques for pixel offset may be utilized to provide this volumetric and depth detail to the stereoscopic 3-D effect applied to the 2-D frame. One such adjustment involves utilizing gradient models corresponding to one or more frame layers or objects to provide a template upon which a pixel offset adjustment may be made to one or more pixels of the 2-D frame. For example, returning to FIG. 2, it may be desired to curve the planet 206 object of the planet layer 230 such that the planet appears to curve away from the viewer of the stereoscopic 3-D frame. To achieve the desired appearance of the planet 206, a gradient model similar in shape to the planet 206 object may be selected and adjusted such that the gradient model corresponds to the planet object and provides a template from which the desired stereoscopic 3-D effect may be achieved for the object. Further, in those layers that include several objects of the 2-D frame, gradient models may be created for one or more objects such that a single stereoscopic 3-D effect is not applied to every object of the layer. In one embodiment, the gradient model may take the form of a gray scale template corresponding to the object, such that when the frame is rendered in stereoscopic 3-D, the whiter portions of the gray scale gradient model corresponds to pixels of the object that appear further along the z-axis position (either in the foreground or background) of the layer than the pixels of the object that correspond to the darker portions of the gradient model, such that the object appears to extend towards or away from the viewer of the stereoscopic 3-D frame. Several techniques related to creating depth models to render a 2-D frame in 3-D are described in greater detail in related United States Patent application titled “GRADIENT MODELING TOOLKIT FOR SCULPTING STEREOSCOPIC DEPTH MODELS FOR CONVERTING 2-D IMAGES INTO STEREOSCOPIC 3-D IMAGES” by Tara Handy Turner et. al., U.S. application Ser. No. 12/571,412 filed Sep. 30, 2009, the entirety of which is incorporated by reference herein.

Once the desired depth pixel offset and the adjusted pixel offset based on a volume effect or gradient model are determined for each layer and pixel of the 2-D frame in operation 120, corresponding left eye and right eye frames are generated for each layer in operation 130 and shifted in response to the combined pixel offset in operation 140 to provide the different perspectives of the layer for the stereoscopic visual effect. For example, to create a left eye or right eye layer that corresponds to a layer of the 2-D frame, a digital copy of the 2-D layer is generated and shifted, either to the left or to the right in relation to the original layer, a particular number of pixels based on the pixel offset for relative perceptual z-axis positioning and/or individual object stereoscopic volume pixel offsetting. Hence, the system generates a frame copy of the layer information with the x-axis or horizontal pixel values shifted uniformly some value to position the object along a perceptual z-axis relative to other objects and/or the screen, and the system further alters the x-axis or horizontal pixel position for individual pixels or groups of pixels of the object to give the object stereoscopic volume. When the corresponding left eye and right eye frames are viewed simultaneously or nearly simultaneously, the object appearing in the corresponding frames appears to have volume and to be in the foreground or background of the stereoscopic 3-D frame, based on the determined pixel offset.

In general, the shifting or offsetting of the left or right eye layer involves the horizontal displacement of one or more pixel values of the layer. For example, a particular pixel of the left or right eye layer may have a pixel color or pixel value that defines the pixel as red in color. To shift the left or right eye layer based on the determined pixel offset, the pixel value that defines the color red is horizontally offset by a certain number of pixels or other consistent dimensional measurement along the x-axis or otherwise horizontal, such that the new or separate pixel of the layer now has the shifted pixel value, resulting in the original pixel horizontally offset from the copy. For example, for a pixel offset of 20, a pixel of the left or right eye layer located 20 pixels either to the left or the right is given the pixel value defining the color red. Thus, there is a copy of the pixel horizontally offset (x-offset) from the original pixel, both with the same color red, 20 pixels apart. In this manner, one or more pixel values of the left or right eye layer are horizontally offset by a certain number of pixels to created the shifted layer. As used herein, discussion of “shifting” a pixel or a layer refers to the horizontal offsetting between the original pixel value and its copy.

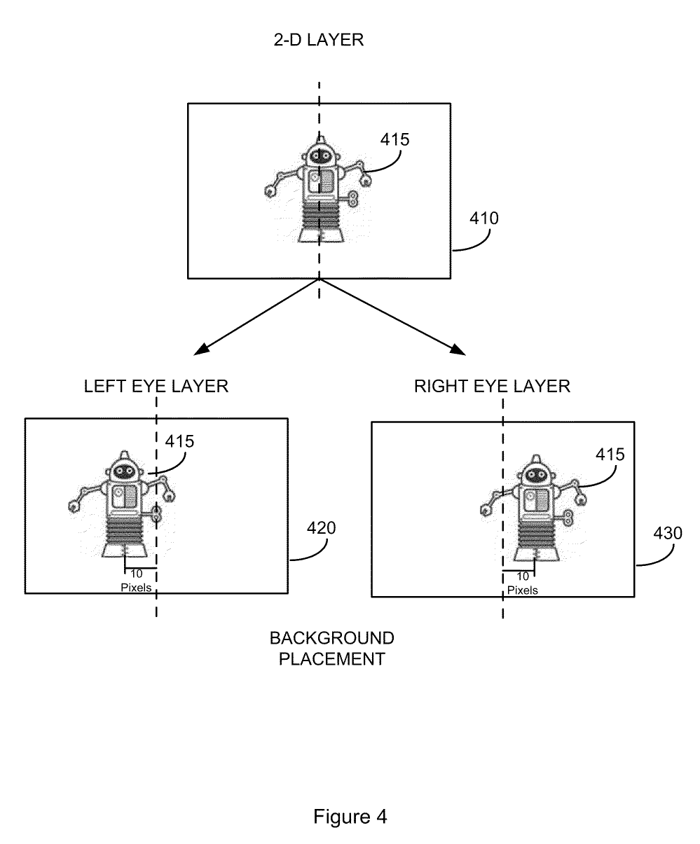

FIG. 4 is a diagram illustrating the creation of corresponding left eye and right eye layers from a 2-D layer, with both left eye and right eye layers shifted such that the total pixel shift of the layers equals the depth pixel offset. As shown in FIG. 4, a left eye layer 420 and a right eye layer 430 are created from the 2-D layer 410 such that the combination of the left eye layer and the right eye layer provides a stereoscopic 3-D effect to the contents of the layer. In this embodiment, the left eye layer 420 is shifted to the left while the right eye layer 430 is shifted to the right along the x-axis in response to a pixel offset. Generally, the shifting of the left eye and/or right eye layers occur in the x-axis only. When the shifted right eye layer 430 and the shifted left eye layer 420 are viewed together, the robot character 415 appears in the background, or behind the screen plane. To place a layer in the foreground of the stereoscopic 3-D frame, the corresponding left eye layer 410 is shifted to the right while the right eye layer 420 is shifted to the left along the x-axis. When the shifted right eye layer 420 and the shifted left eye layer 410 are viewed together, the robot character 415 appears in the foreground of the frame, or in front of the screen plane. In general, the depth pixel offset is achieved through the shifting of one of the left eye or right eye layers or the combined shifting of the left eye and the right eye layers in either direction.

The number of pixels that one or both of the left eye and right eye layers are shifted in operation 140 may be based on the depth pixel offset value. In one example, the pixel offset may be determined to be a 20 total pixels, such that the layer may appear in the background of the stereoscopic 3-D frame. Thus, as shown in FIG. 4, the left eye layer 420 may be shifted ten pixels to the left from the original placement of the 2-D layer 410, while the right eye layer 430 may be shifted ten pixels to the right. As can be seen, the robot character 415 of the left eye layer 420 has been displaced ten pixels to the left of the center depicted by the vertical dashed line while right eye layer 430 has been displaced to the right of center by ten pixels. Thus, the total displacement of the layers between the left eye layer 420 and the right eye layer 430 is 20 pixels, based on the determined pixel offset. It should be appreciated that the particular number of pixels that each layer is shifted may vary, as long as the number of pixels shifted for both layers equals the overall pixel offset. For example, for a 20 pixel offset, the left layer may be shifted five pixels while the right layer may be shifted 15 pixels. Shifting the left and right eye layers in this way will result in a slightly different perspective of the layer than shifting in equal amounts, but this result may generate a desired creative effect or may be negligible to the viewer while being advantageous for the purposes of simplifying an image processing step such as the extraction of the layer.

Returning to FIG. 1, in operation 150, the computer system adjusts the pixel offset of a layer or object based on a stereoscopic volume or applied gradient model. The system orients a given object or layer along a perceptual z-axis by generating a copy of the object or layer and positioning the object and its copy relative to each other along an x-axis or horizontally. The degree of relative positioning determines the degree of perceptual movement fore and aft along the perceptual z-axis. However, a given object initially appears flat as the object and its copy are uniformly displaced. To provide an object with stereoscopic volume and depth, portions of an object and the corresponding portion of the object copy are relatively positioned differently (more or less) than other portions of the object. For example, more or less x-axis pixel offset may be applied to some portion of an object copy relative to other portions of an object copy, to cause the perceived position of some portion of the object to be at a different position along the perceptual z-axis relative to other portions of the object when the left and right eye layers are displayed.

In one embodiment, a separate gray scale template is created and applied to an object of the 2-D frame such that, after application of the pixel offset to the left eye layer and the right eye layer at a percentage indicated by the gray scale value of the template image at that pixel location, the whiter portions of the gray scale correspond to pixels in the image that appear further in the foreground than the darker portions. Stated differently, the gray scale provides a map or template from which the adjusted pixel offset for each pixel of an object may be determined. In this manner, a stereoscopic volume is applied to an object. The same gray scale may be generated by utilizing one or more gradient modeling techniques.

Therefore, based on the determined depth pixel offset (which perceptually positions a layer along the perceptual z-axis of the stereoscopic 3-D frame) and the gradient model pixel offset (which adjusts the depth pixel offset for one or more pixels of an object to provide the object with the appearance of having volume and a more detailed depth), the left eye layer and right eye layer, and specific portions of the left and/or right eye layer, are shifted to provide the stereoscopic 3-D frame with the desired stereoscopic 3-D effect. Thus, in some embodiments, each pixel of a particular stereoscopic 3-D frame may have an associated pixel offset that may differ from the pixel offsets of other pixels of the frame. In general, any pixel of the 2-D frame may have an associated pixel offset to place that pixel in the appropriate position in the rendered stereoscopic 3-D frame.

Operations 110 through 150 may repeated for each layer of the 2-D frame such that corresponding left eye layers and right eye layers are created for each layer of the frame. Thus, upon the creation of the left eye and right eye layers, each layer of the frame has two corresponding layers (a left eye layer and a right eye layer) that is shifted in response to the depth pixel offset for that layer and to the volume pixel offset for the objects of the layer.

In operation 160, the computer system combines each created left eye layer corresponding to a layer of the 2-D frame with other left eye layers corresponding to the other layers of the 2-D frame to construct the complete left eye frame to be presented to the viewer. Similarly, the computer system combines each right eye layer with other right eye layers of the stereoscopic 3-D frame to construct the corresponding right eye frame. The combined left eye frame is output for the corresponding stereoscopic 3-D frame in operation 170 while the right eye frame is output for the corresponding stereoscopic 3-D frame in operation 180. When viewed simultaneously or nearly simultaneously, the two frames provide a stereoscopic effect to the frame, converting the original 2-D frame to a corresponding stereoscopic 3-D frame. For example, some stereoscopic systems provide the two frames to the viewer at the same time but only allows the right eye to view the right eye frame and the left eye to view the left eye frame. One example of this type of stereoscopic systems is a red/cyan stereoscopic viewing system.

In other systems, the frames are provided one after another while the system limits the frames to the proper eye. Further, to convert a 2-D film to a stereoscopic 3-D film, the above operations may be repeated for each frame of the film such that each left eye and right eye frame may be projected together and in sequence to provide a stereoscopic 3-D effect to the film.

By performing the operations of the method illustrated in FIG. 1, a layer or portions of the layer of a 2-D frame may have a depth pixel offset associated with the position of the layer in the stereoscopic 3-D frame and/or a volume pixel offset to provide an object or region of the layer with a perceptual position (e.g. at, fore or aft of a screen) and/or stereoscopic volume effect. Thus, certain depth information associated with the perceptual depth of the layers and objects of the stereoscopic 3-D frame may be maintained and utilized by an animator or artist to determine and adjust the appearance of objects and layers of the stereoscopic 3-D frame. Aspects of the present disclosure provide a user interface and method that displays such depth and volume information for each layer of the stereoscopic 3-D frame, as well as additional depth and stereoscopic production information derived from the maintained depth information. Further, such information may be adjusted in response to a change in one or more of the depth values for the one or more layers of the stereoscopic frame. Further still, the user interface maintains such depth information for several frames such that a user may access and alter the depth information for any of one or more layers of the stored frames through the user interface.

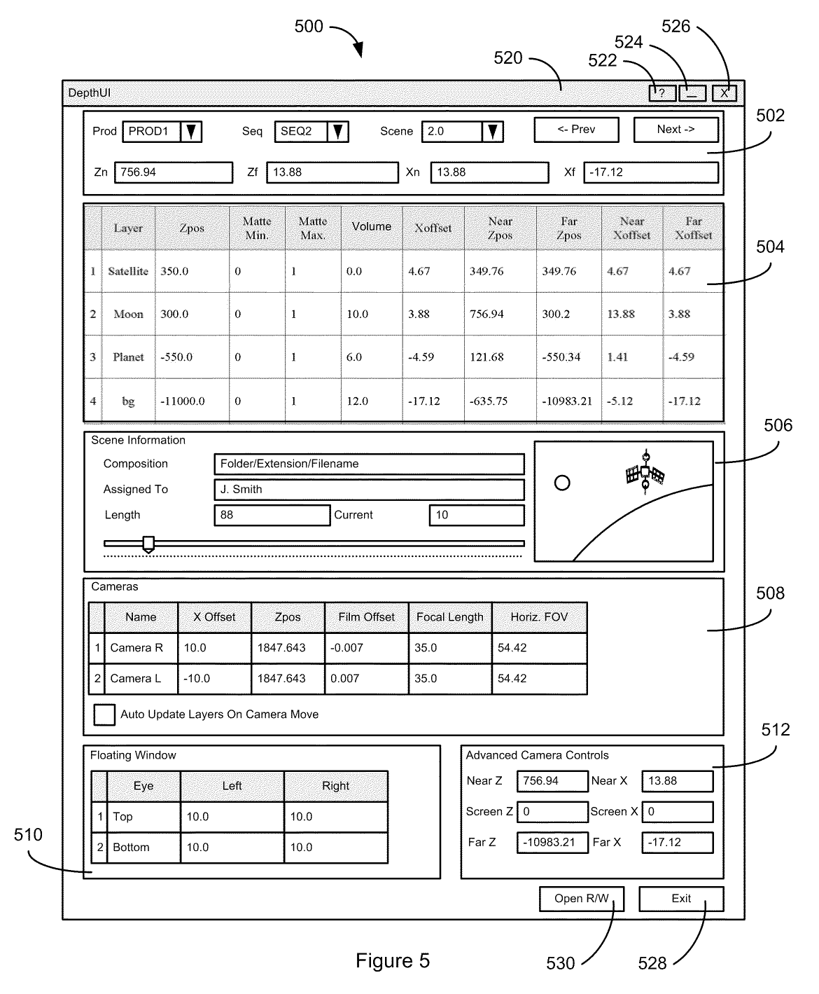

FIG. 5 is a diagram illustrating a user interface 500 displaying depth and volume information for one or more layers of a stereoscopic 3-D frame or frames and for choreographing stereoscopic depth information between the layers of the stereoscopic 3-D frames. The user interface 500 may be generated by a computing device and displayed on a monitor or other display device associated with the computing device. Further, the computing device may communicate with a database configured to store one or more layers of a 2-D or stereoscopic 3-D frame or several such frames to access the frames and depth information for the frames.

The user interface 500 may take the form of the interface of a computer software program including a header bar 520 providing a help button to access a help menu, a minimize button 524 to minimize the interface window and a exit button 526 to exit the interface located along the top of the user interface. The user interface 500 also includes several sections or modules that provide different functionality and depth information to a user of the interface. More particularly, the user interface 500 includes a navigation module 502, a layer depth information module 504, a scene information module 506, a virtual camera module 508, a floating window module 510 and an advanced virtual camera control module 512. In general, such modules provide the user with depth and volume information for a stereoscopic 3-D frame or frames, including depth and volume information for each layer of the 3-D frame.

In addition, the user interface 500 allows a user to input depth values into the interface to provide an object or layer of a stereoscopic 3-D frame a perceived depth. In other words, the user interface 500 may be utilized by an artist or animator to provide the objects and/or layers of a stereoscopic frame with a desired pixel offset or z-axis position such that the object or layer appears to have depth within the stereoscopic frame. Further, the artist or animator may utilize the user interface 500 to alter or change the perceived depth for the one or more objects or layers of the stereoscopic frame. For example, a particular stereoscopic 3-D frame includes various depth information for the objects and layers of the frame that are displayed to a user through the user interface 500. Using an input device to the computer system that is displaying the user interface 500, the user may alter the depth values for one or more layers or objects of the stereoscopic frame to adjust the perceived depth of the layers or objects.

In one embodiment, the user interface 500 includes an “Open R/W” button 530, located along the bottom of the interface in the example shown. The Open R/W button 530, when pressed or otherwise selected by the user utilizing an input device to the computing system, can be made to apply any changes input by the user to the selected stereoscopic 3-D frame using underlying software. Thus, if the user enters new depth information or alters existing depth information into the user interface 500, the underlying stereoscopic frame is altered in response. For example, the user may move a particular layer of the stereoscopic frame into the background of the frame by providing the layer with a negative z-axis value or corresponding pixel offset value through the user interface 500. However, if the Open R/W button 530 is not selected, than any parameters provided to the user interface 500 by the user only alters the resulting calculations of the other related depth values displayed by the interface for viewing purposes by the user. Thus, in this mode, the altered values are not applied to the stereoscopic frame until indicated by the user. Rather, the altered or input values are utilized strictly to calculate the depth values for the composite stereoscopic frame. This mode may also be referred to as the “calculation mode” as only calculations are performed and no actual changes are applied to the selected stereoscopic 3-D frame. In addition, an exit button 528 allowing the user to exit the interface is also provided.

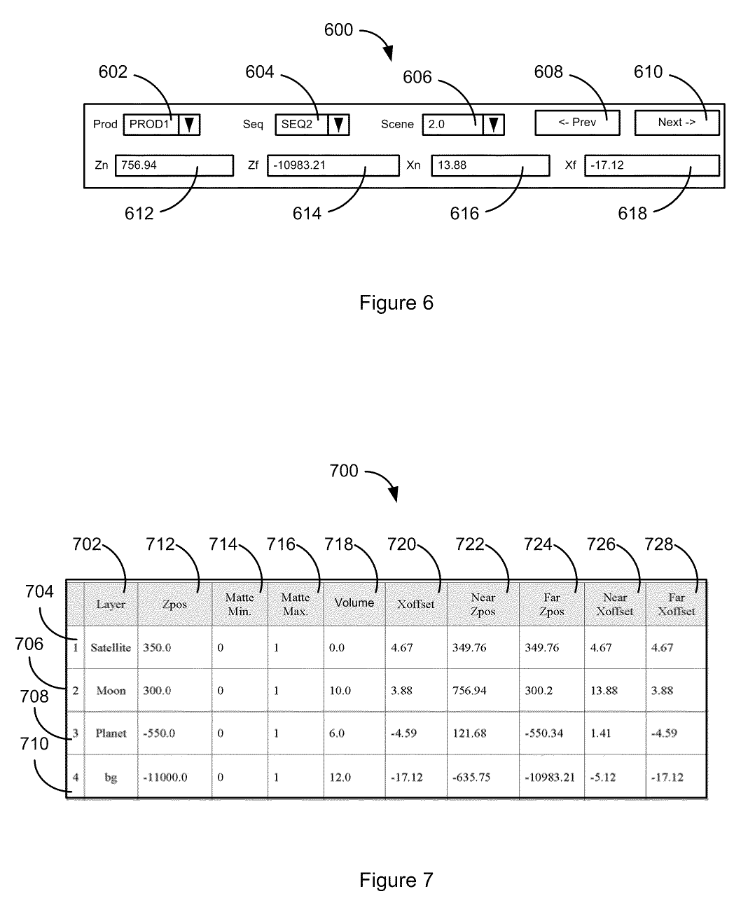

The user interface may include a number of modules that display a variety of depth information of a stereoscopic 3-D frame along with the option to edit such information. FIG. 6 is a diagram illustrating a navigation and scene information module 600 of the user interface displaying scene information and navigation tools for a stereoscopic 3-D frame. The navigation and scene information module 600 generally provides information on the selected stereoscopic 3-D frame, as well as the functionality to navigate to other frames within a multimedia presentation, such as an animated stereoscopic film. Further, the navigation and scene information module 600 provides near and far extreme depths for the stereoscopic 3-D frame as a whole.

The user interface 500 displays depth information for a particular stereoscopic 3-D frame. In one embodiment, the selected or displayed stereoscopic frame may be a single frame of a multimedia presentation that includes multiple frames. For example, the selected frame may be a single frame from an animated stereoscopic film involving several frames that, when displayed in sequence, provide a stereoscopic 3-D animated film. For such presentations, each frame is identified by one or more production numbers that describe the placement of the frame within the sequence of frames that comprise the presentation. In particular, any one or more frames that display a specific event over time in a specific environment from a specific camera angle (point of view) may be grouped together and referred to as a “scene.” The frame is identified within that scene using the numerical position of that frame with respect to the other frames in the scene. For example, frame 10 could be the 10^{th} frame in a series of frames displaying the robot, satellite, planet and moon in FIG. 3. Further, any one or more scenes, i.e. events/camera angles, in that same environment may be grouped with that scene and referred to as a “sequence.” For example, a close-up of the robot just after the events of the scene above could be a part of a sequence in that environment. And finally, any one or more sequences, i.e. environments, may be grouped together and referred to as a “production.” That is, all other events and environments that are represented in the multimedia presentation, for example events at the control center for the robot, events the next evening at the home of a character who built the robot, events surrounding the robot, satellite, planet and moon several days later, etc. The term, production, then, in this example, may be used to refer to the entire multimedia presentation. A frame in a multimedia presentation can therefore, as in this example, be uniquely identified by production, sequence, scene, and frame number. In the example shown in FIG. 6, the selected stereoscopic 3-D frame is identified by production identifier 602 (showing value “PROD1”) representing a production identification number, sequence identifier 604 (showing value “SEQ2”) representing a sequence identification number and scene number 606 (showing value “2.0”) representing a scene identification number. These values define the selected frame of a multimedia presentation that is displayed by the user interface 500. To select the particular frame for viewing, a user may either input the production, sequence and scene numbers, or may access a drop down menu associated with each identifier 602-606 to select the desired frame to be viewed using the user interface. In addition to the frame identification values, the navigation and scene information module 600 also includes a previous button 608 and a next button 610. By utilizing these buttons, a user selects the previous or next scene in the sequence of scenes that comprise the multimedia presentation and can thereby efficiently scroll forward or backward scene-by-scene while editing or creating a stereoscopic presentation. While the example shown uses production, sequence, scene and frame identifiers to identify the selected frame, any production values may be used to identify the selected frame. Once a stereoscopic frame is selected through the navigation and scene information module 600, the depth information for that frame is displayed, and optionally edited by the user, in the user interface 500.

One example of such depth information is provided in the navigation and scene information module 600. More particularly, the navigation and scene information module 600 provides the extreme near and far depth information for the selected stereoscopic frame. For example, the navigation and scene information module 600 includes a “Zn” value 612 that provides the nearest z-axis position value of the nearest object in the stereoscopic frame. Similarly, a far z-axis position value is provided as the “Zf” value 614. This value provides the depth of the farthest object in the stereoscopic frame. The z-axis position values can best be understood with reference to FIG. 3. As shown, those layers of objects of the stereoscopic frame that appear in the foreground of the frame are given a positive z-axis value while those layers or objects in the background of the frame are given a negative z-axis value. Further, the more extreme the z-axis value, the further into the foreground or background the object appears. In this manner, and returning to FIG. 6, the Zn value 612 displayed in the navigation and scene information module 600 provides the z-axis position of the object that is nearest into the foreground of the selected stereoscopic frame while the Zf value 614 provides the z-axis position of the object furthest into the background of the frame. Thus, in the example shown, the nearest object has a z-axis position of 756.94 while the object furthest into the background of the stereoscopic frame is −10983.21.

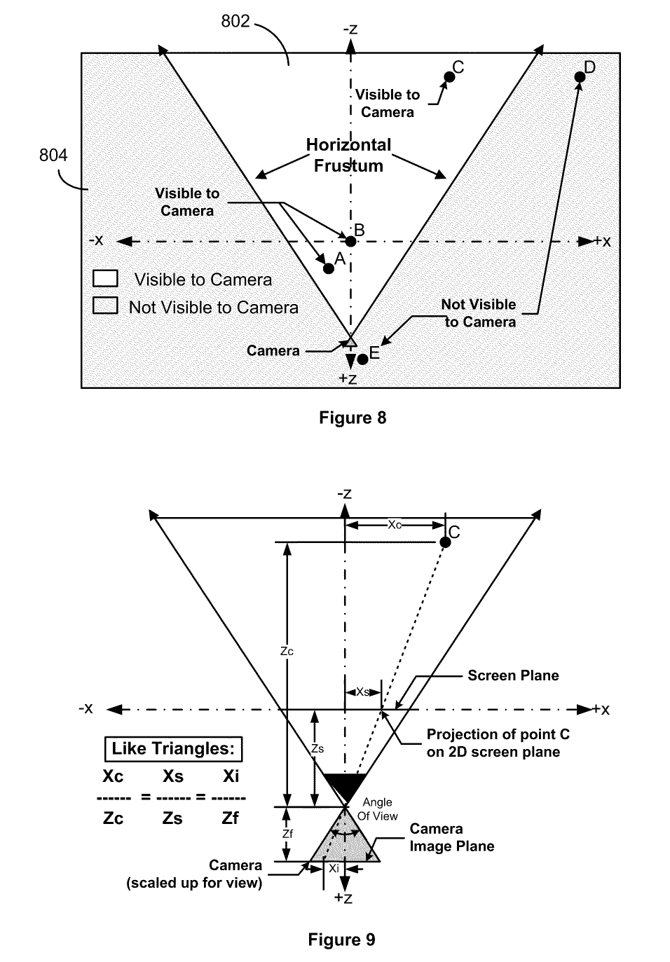

It may be noted that the upper and lower bounds of the z-axis values are determined by the position and viewing area, or frustum, of the real or virtual camera. The frustum is the area of view defined by the focal length, angle of view, and image size attributes of the real or virtual camera and lens. As an example, FIG. 8 shows a top-down view of a virtual camera and five points (A, B, C, D and E) either within or outside the viewing area. The horizontal frustum 802, or area of view in the X-Z camera space, is indicated by the white region. All points inside that region 802 from the front of the camera to infinity are visible by the camera. All points in the shaded region 804 outside that area are not visible by the camera. In this example, points A, B and C are visible by the camera. However, point D, although it is located at the same z-axis position as point C, is not visible by the camera because it is outside the horizontal frustum 802. Also, point E is not visible by the camera because it is behind the camera position.

Further still, the values provided by the module 600 may take into account any volume effect applied to the objects of the frame. For example, the Zn value 612 provides the nearest z-axis foreground point in the stereoscopic frame after any volume effects are applied to the nearest objects in the foreground. Similarly, the Zf value 614 provides the furthest z-axis background point after any volume effects are applied to the furthest objects in the background of the frame.

The navigation and scene information module 600 also provides an Xn value 616 and a Xf value 618 that are related to the Zn value 612 and the Zf value 614. The Xn value 616 provides the same depth information as the Zn value 612, however this value is expressed in a pixel offset or x-axis offset value rather than a z-axis position value. The relationship between x-axis offset and the z-axis position is derived from the principles of 3D projection, or more specifically the position, rotation, focal length, angle of view, and image size attributes of a real or virtual camera and lens. Generally, in a single-camera system a point in three dimensional space is “projected” onto a two dimensional screen plane and camera image plane at a specific point depending on the values of the parameters above. In FIG. 9, it is shown that through the principle of similar triangles, the x-axis projection of point C from FIG. 8 on both the screen plane and the camera image plane is proportional to the x-axis and z-axis position of point C, the screen plane and the camera. That is, (Xc, point C x-axis position/Zc, point C z-axis position)=(Xs, screen plane x-axis projection position/Zs, screen plane z-axis position)=Xi, image plane x-axis projection position/Zf, focal length.) This holds true for points located in front, behind or at the screen plane location.

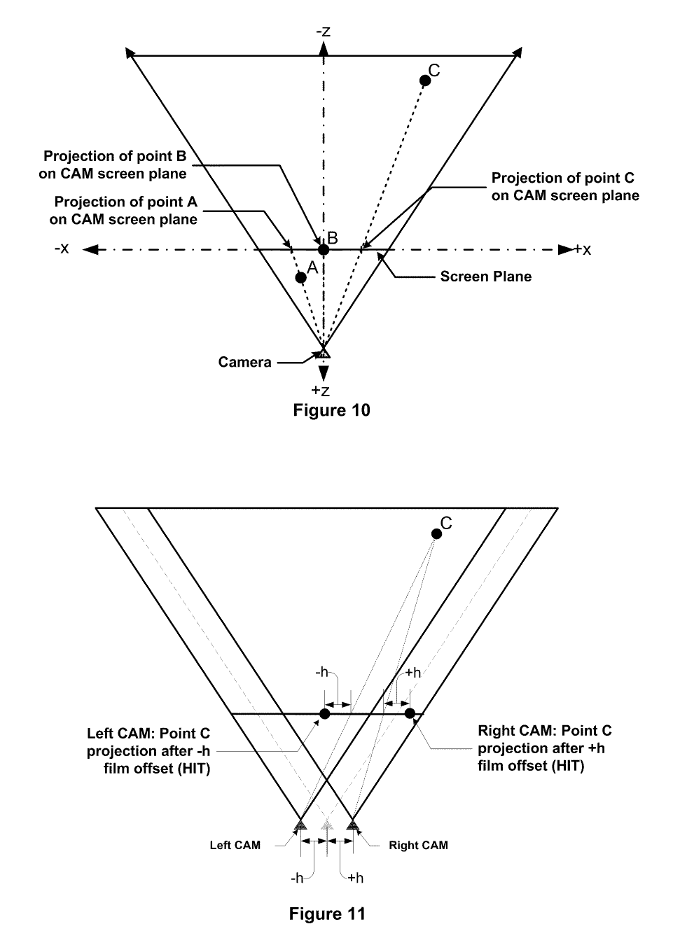

This can be further seen in relation to FIG. 10. In FIG. 10, it can be seen that point C behind the screen and right of center, projects at a positive x-axis position while point A in front of the screen plane and left of center projects at a negative x-axis position and point B projects at 0 x-axis position because it is located along the center axis, with zero offset in the x direction. Stereoscopic processing effectively reverses the 3D projection process and places the point back into the appropriate z-axis position when generating left eye and right eye perspective views. For example, as shown in FIG. 11, if two cameras are added to the camera in FIG. 9 and shifted to the left and right, respectively, point C will be projected on the image and screen planes of those cameras at a position slightly offset in the x-axis from the same point on the center camera. These offsets are directly related to the x-axis offset values described herein for defining and adjusting stereoscopic depth of an object or point. Through triangulation of the left camera and right camera offsets, the depth of the point may be defined. Thus depth can be described by either the actual z-axis position of a point or the equivalent x-axis offset between two cameras of the projection of that point. Thus, the Xn value 616 provides the pixel offset for the pixels of the object that are nearest the viewer in the foreground of the stereoscopic frame. The Xf value 618 provides the pixel offset for the pixels of the object that is furthest into the background of the stereoscopic frame. In addition, the Xn value 616 and the Xf value 618 account for any volume effects applied to the stereoscopic frame in a similar manner as the Zn value 612 and Zf value 614. Also of consideration for stereoscopic processing of a 2D image is that in most stereoscopic systems, the left and right cameras are made to converge on a center point, usually at the center of the screen plane, either by rotating each camera inward and correcting for keystone affects or orienting the cameras parallel to each other and offsetting the final image of each by their distance from center (known as Horizontal Image Translation, or HIT.) These techniques are accounted for by the camera information module of the user interface and the underlying calculations that convert between the z-axis depths and x-axis offsets displayed in the interface.

FIG. 7 is a diagram illustrating a second module of the depth information user interface 500. The layer depth information module 700 of the user interface displays depth information for one or more layers of the selected stereoscopic 3-D frame. As mentioned, the stereoscopic frame may be comprised of one or more layers, with each layer including an object or several objects of the frame. The layer depth information module 700, therefore, provides depth information for each layer that comprises the selected stereoscopic 3-D frame.

In a layer column 702, each layer of the stereoscopic frame is identified by name. In the example shown, four layers comprise the selected frame, namely a satellite layer 704 (corresponding to 220 of FIG. 2), a moon layer 706 (corresponding to 210 of FIG. 2), a planet layer 708 (corresponding to 230 of FIG. 2) and a background layer 710, labeled here as “bg”. Each layer may include an object or several objects of the stereoscopic frame. Associated with each labeled layer of the stereoscopic frame is a z-axis position value, indicated in a Zpos column 712. The values stored in the Zpos column 712 provide the z-axis position of the layer within the stereoscopic frame, generally before any volume effects are applied to the objects of the layer. Thus, because the satellite layer 704 and the moon layer 706 have a positive value in the Zpos column 712 as shown, these layers are located in the foreground of the stereoscopic frame. Similarly, because the planet layer 708 and the bg layer 710 have a negative value in the Zpos column 712, these layers are located in the background, or behind the screen plane, of the stereoscopic frame. Further, the user can surmise, based on the values indicated in the Zpos column 712, that the layers appear to the viewer in the order listed in the layer depth information module 700 because the Zpos values 712 are listed from the highest positive value to the highest negative value. It is not required, however, that the layers 704-710 of the stereoscopic 3-D frame be listed as they appear in the stereoscopic frame. Generally, the layers 704-710 may be listed in any order in the layer depth information module 700.

The matte min column 714 and the matte max column 716 defining the minimum and maximum grayscale value of the depth model applied to the object or objects of that layer are also included in the layer depth information module 700. In the example shown, the depth models applied to the layers include grayscale values that range from zero to one. However, the maximum and minimum grayscale values may comprise any range of values. This range may be determined by analyzing the depth model for each layer for maximum and minimum values. Further, these values may be adjusted by a user of the user interface or the computing system to apply more or less volume to the layers of the frame. The amount of volume applied to the layer at any pixel is equal to the value of the grayscale map at that pixel multiplied times the volume value shown in column 718 of that layer. For example, the moon layer 706 in the depth information module 700 has a depth model with minimum and maximum grayscale values of 0 and 1.0, respectively, as shown in columns 714 and 716. The moon layer has a volume value of 10.0 as shown in column 718. Therefore the maximum x offset displacement defined by the volume effect is (1.0×10.0) or 10 pixels. However, if the maximum grayscale values of the depth model had, instead, a value of 0.8, the x offset displacement would be (0.8×10.0) or 8 pixels at those pixels with maximum value in the grayscale model.

An volume column 718 is also included in the layer depth information module 700 that defines the amount of volume given to the objects of the particular layer at the selected frame. For example, for the satellite layer 704 shown, no volume is applied to the objects of the layer. This is indicated by the volume value being set at 0.0. Conversely, the moon layer 706 has a volume value of 10.0 in the volume column 718. Thus, the object or objects of the moon layer have a maximum volume offset of 10.0 pixels applied to the objects of the moon layer. The 10.0 volume value of the moon layer 706 corresponds to a pixel offset of 10 times the depth model value at each pixel. This corresponds to a pixel offset of 10 pixels at the extreme volume point of the moon object. Volume values are also given for the planet layer 708 and the bg layer 710 of the stereoscopic frame. Particularly, the objects of the planet layer 708 are offset by a maximum of six pixels and the objects of the background layer 710 are offset by a maximum of 12 pixels.

The layer depth information module 700 also includes an Xoffset column 720 that includes pixel offset values that relate to the values in the Zpos column 720. In other words, the values in the Xoffset column 720 define the total pixel offset for the layer that is applied to the layer such that the layer is perceived at the corresponding Zpos value 712 for that particular layer. Thus, as shown, the satellite layer 704 has a Zpos value of 350.0, meaning that the layer is perceived in the foreground of the stereoscopic frame. To achieve this z-axis placement, a pixel offset of 4.67 (the value shown in the Xoffset column 720 for that layer) is applied to the layer. Thus, similar to the Zpos value for each layer, the Xoffset column 720 define the perceived depth placement for the particular layer of the selected frame.

In addition, the layer depth information module 700 includes a near Zpos column 722, a far Zpos column 724, a near Xoffset column 726 and a far Xoffset column 728 for each layer of the frame. These values are similar to the Zn, Zf, Xn and Xf values described above with reference to FIG. 6. However, the values displayed in FIG. 7 apply to the individual layers of the stereoscopic frame, instead of to the frame as a whole. Further, the values in these columns 722-728 include any volume effects applied to the layer. Thus, the moon layer 706 has a near z-position, after volume effect, of 756.94, a far z-position of 300.2, a near x-offset of 13.88 and a far x-offset of 3.88.

Through the values included in the layer depth information module 700, a user can identify the stereoscopic attributes applied to any feature of a scene, and can also modify the look and feel of the layers of the selected stereoscopic frame. For example, the user interface shows that the moon layer, including the moon object of the moon layer, has a z-axis position of 300.0, putting the layer in the foreground of the stereoscopic frame. Further, a pixel offset of 3.88 pixels is applied to the layer to achieve the z-axis position of 300.0, as shown in the Xoffset column 720. The user can modify the stereoscopic positioning of the moon layer relative to the other layers of the scene by altering the pixel offset values or z-axis position values maintained in the layer depth information module 700. In addition, the user interface shows that the moon object of the moon layer has a maximum volume offset of 10.0 pixels (from volume column 718 and Matte Max column 716). The user interface also shows that the volume effect of the moon object provides volume to the object in the positive z-axis direction or, stated otherwise, the moon object is inflated into the foreground of the stereoscopic frame. This can be identified because the near Xoffset value (13.88 pixels) in the near Xoffset column 726 for the moon layer 706 equals the Xoffset value (3.88 pixels) plus the volume value (10.0 pixels). In other words, the pixel of the moon object that is nearest the viewer has a pixel offset of 13.88 pixels, or 10.0 pixels from the Zpos of the layer. Similarly, the far Xoffset of the layer is the same the Xoffset for the entire layer, namely 3.88 pixels. Finally, the user interface also shows that the moon object extends further into the foreground of the stereoscopic frame than any other object, as the near Zpos of the moon layer (756.94) is further along the z-axis than any other layer of the frame.

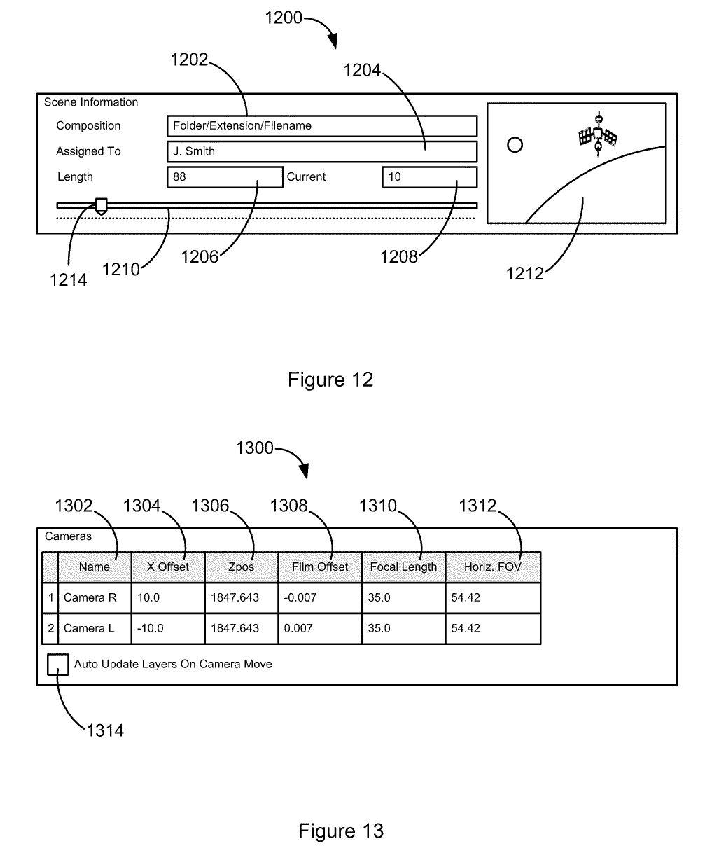

The user interface 500 also includes a scene information module 1200 for displaying information of the selected stereoscopic 3-D frame. FIG. 12 is a diagram illustrating the scene information module 1200 of the user interface. As mentioned, the selected frame presented in the user interface may be a part of a scene of a multimedia presentation, such as an animated film. Thus, the scene information module 1200 includes further identification information for the scene or collection of frames from which the selected stereoscopic frame is a part. For example, the scene information module 1200 includes a composition indicator 1202 that provides the storage location of the stereoscopic scene, including the folder and filenames for the scene. The scene information module 1200 also includes an operator identifier 1204 that identifies the operator to which the scene is assigned. Further, a length indicator 1206 provides the length of the scene in number of frames and a current indicator 1208 provides the frame number for the selected frame within the scene. For example, the frame selected in FIG. 12 is the tenth frame of a scene that is 88 frames in length. A 2-D representation 1212 of the selected stereoscopic frame is also included in the scene information module 1200. Other embodiments may also provide depth information within the 2-D representation of the stereoscopic frame itself. Several of such embodiments are discussed in detail in related United States Patent Application titled “APPARATUS AND METHOD FOR INDICATING DEPTH OF ONE OR MORE PIXELS OF A STEREOSCOPIC 3-D IMAGE COMPRISED FROM A PLURALITY OF 2-D LAYERS” by Tara Handy Turner et. al., Attorney Docket No. P200060.US.01, the contents of which are incorporated in their entirety by reference herein.

A slide bar 1210 is also provided to allow the user of the interface to select which frame of the scene is selected as the “current” frame. Thus, in one embodiment, the user utilizes an input device to the computer system, such as a mouse, to grab a slider 1214 of the slide bar 1210 and move the slider along the slide bar, either to the left or to the right. In response, the frame number maintained in the current indicator 1208 may adjust accordingly. For example, if the slider 1214 is moved right along the slide bar 810, the value in the current frame indicator 1208 increases. In addition, the frame shown in the 2-D representation panel 1212 may also adjust accordingly to display the current frame. In a further embodiment, each depth value maintained and presented by the user interface adjusts to the selected frame shown in the current indicator 1208 as the slider 1214 is slid along the slide bar 1208 by the user.

A virtual camera module 1300 is also included in the user interface 500 to display depth information and virtual camera placement for the selected stereoscopic 3-D frame. FIG. 13 is a diagram illustrating one embodiment of the virtual camera module 1300. The virtual camera module 1300 provides information for one or more virtual cameras that may be used to create or simulate the stereoscopic effects for the selected stereoscopic frame.

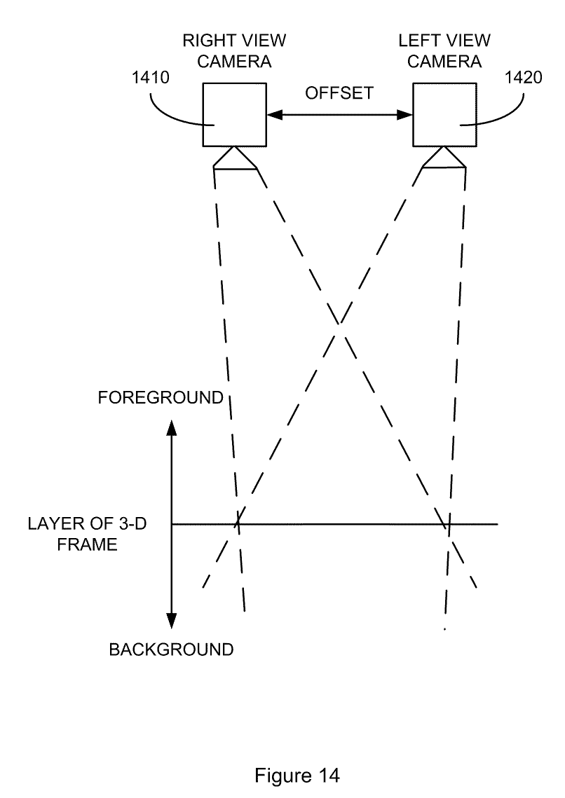

The values maintained by the virtual camera module 1300 may best be understood with reference to FIG. 14. FIG. 14 is a diagram illustrating a virtual two camera system obtaining the left eye and right layers to construct a stereoscopic 3-D frame. In FIG. 14, a right view camera 1410 takes a right view virtual photo of the object or layer of the stereoscopic frame while a left view camera 1420 takes a left view virtual photo of the same layer. The right view camera 1410 and the left view camera 1420 are offset such that each camera takes a slightly different virtual photo of the layer. These two views each provide the left eye and right eye layers useful for generating a stereoscopic 3-D frame. In this manner, two or more virtual cameras may be utilized to create the left eye and right eye versions of a layer of the stereoscopic 3-D frame.

The virtual camera module 1300 of FIG. 13 provides information on the placement of the virtual cameras that may be utilized to create or simulate the selected stereoscopic 3-D frame. This information includes a camera column 1302 that provides the labels, if applicable, given to the virtual cameras used to create the stereoscopic frame. An X offset column 1304 is also provided that includes an x-offset value for each of the identified cameras. This value establishes the position in the horizontal or x-axis for the identified cameras in relation to the selected frame and the distance between these values is generally referred to as the inter-axial distance of the camera system. In the example shown, the right view camera (labeled “Camera R”) is 10.0 pixels, or ten pixels to the right from the center of the selected frame. The left view camera (labeled “Camera L”) is a −10.0 pixels, or ten pixels to the left from the center of the selected frame. These values correspond to an inter-axial distance of 10—(−10) or 20 pixels. Similarly, the virtual camera module includes a Zpos column 1304 providing the position, along the perceptual z-axis, of the identified cameras. In the example shown, both of the identified cameras are located at a z-axis position of 1847.643.

Other camera values are also presented in the virtual camera module 1300. For example, a film offset column 1308 is provided for each identified virtual camera defining the convergence point for the cameras. The Horizontal Image Translation, or HIT, value for the virtual cameras may be adjusted by the user of the user interface to alter the convergence point for the camera by editing the value or values maintained in the film offset column 1308. For example, a user may use one or more input devices (such as a mouse or keyboard) to the computing device to input a value into the film offset column 1308. Similarly, a horizontal field of view (FOV) column 1312 is also provided. The values in this column define the horizontal area that the virtual camera includes. The x-offset, z-axis position and focal length values may be similarly adjusted by a user of the interface by editing the maintained values to adjust the images taken by the cameras.

The virtual camera module 1300 also includes a checkbox 1314 that allows the user to adjust the camera parameters within the virtual camera module 1300 such that the user interface programmatically adjust the depth and volume information for each of the layers displayed in the layer depth information module. Thus, by selected the checkbox 1314, any changes to the camera values are shown in the other depth information provided by the user interface. For example, a user of the user interface may alter the focal length of one of the virtual cameras by editing the focal length value 1310 for that camera in the virtual camera module 1300. In response, the values that define the z-axis position and corresponding x-offset of the layers of the selected scene may be calculated and altered by the user interface to reflect the alteration to the virtual camera. In this manner, a user may alter the depth values for the selected scene by editing the virtual camera values maintained in the virtual camera module 1300.

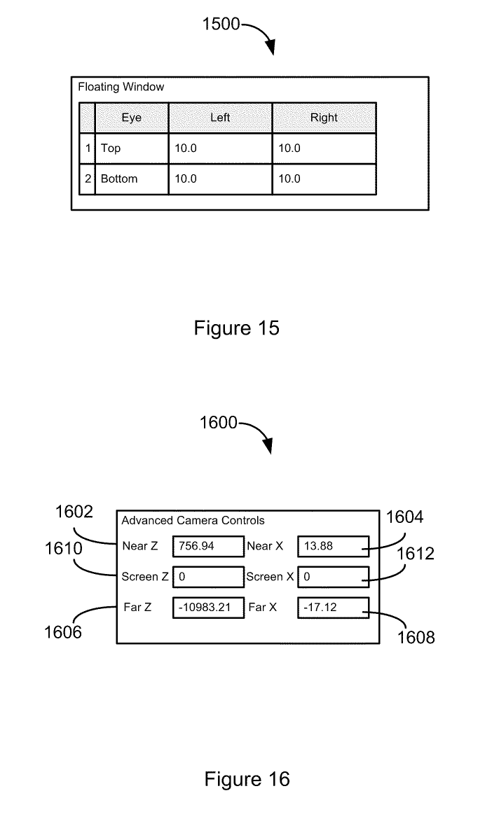

FIG. 15 is a diagram illustrating a floating window module of the user interface displaying eye boundary information of a stereoscopic 3-D frame. In some instances, a stereoscopic frame includes a floating window or crop to ensure that objects that move offscreen do not cause conflicting depth cues to the viewer. For example, if an object is positioned in front of the screen plane in depth but it's image pixels are cut off by the left or right black edges of the screen plane (such as the left or right edge of a film projection), the black edges appears to occlude or block the object. This implies that the edges of the screen plane are in front of the object. However, the offset between left and right eye pixels have placed the object in front of the screen plane therefore causing viewer difficulty resolving the inconsistent depth cues. To remedy this condition, the left and right black edge locations may be shifted in apparent depth using X offsets, as has been described for objects and layers, to place the apparent edges of the screen plane in front of the object in depth. This removes or minimizes the depth conflict. That is, the X offset, or Z placement of the edge of the frame is positioned closer to the camera than the object and both are positioned in depth in front of the physical screen plane. It is as if the edge of the screen is floating in front of the physical screen and the object it occludes, hence the name floating window. The floating window module 1500 provides information of a floating window that is applied to the frame by the underlying frame manipulation software. In particular, the floating window module 1500 provides the relative x-offset values that define the four corners (top-left, top-right, bottom-left and bottom-right) of the floating window. These values may be adjusted by a user of the user interface or the computing system to alter the apparent position of the screen plane. In the example shown, each corner of the floating window has an x-offset of 10.0.

FIG. 16 is a diagram illustrating an advanced camera control module 1600 of the user interface allowing a user of the interface to edit one or more virtual camera settings and layer depth information of a stereoscopic 3-D frame by altering one or more of the displayed values. The advanced camera control module 1600 provides a single module in which a user may alter the depth values of the selected frame. In one embodiment, an alteration to any value within the user interface will adjust the other displayed values of the interface. In another embodiment, only those values adjusted through the advanced camera control module 1600 will adjust the depth information for the selected stereoscopic frame.

Many of the values presented in the advanced camera control module 1600 are similar to the depth values in the navigation module, including the near z value 1602 providing the nearest position of the frame along the z-axis, the near x value 1604 providing the nearest position of the frame expressed in a pixel offset, the far z value 1606 providing the furthest position of the frame along the z-axis and the far x value 1608 providing the furthest position of the frame expressed in a pixel offset. In addition, the advanced camera control module 1600 also includes a screen z value 1610 that provides the position of the stereoscopic convergence point along the z-axis and a corresponding screen x value 1612 that provides the position of the stereoscopic convergence point expressed in pixel offset. In the example shown, the screen z value 1610 is zero, meaning that the screen plane is located at the zero z-axis position. Similarly, the screen x value 1612 is zero meaning that the screen plane has no pixel offset.

Through the user interface, an operator or user of the interface may choreograph the audience experience of a stereoscopic multimedia presentation. The user interface allows the user to view and optionally edit the depth values of the objects of the stereoscopic images without having to open or access the more complex underlying software that is used for 2-D compositing or 3-D computer graphics. Further, the user interface allows the user to view pertinent parameters of a frame in relation to scenes or frames that come before or after the selected frame. Generally, the user interface described herein provides a tool for an animator or artist to quickly access and view a stereoscopic presentation, with the option of altering the depth parameters of the presentation to enhance the viewing experience of a viewer of the presentation.

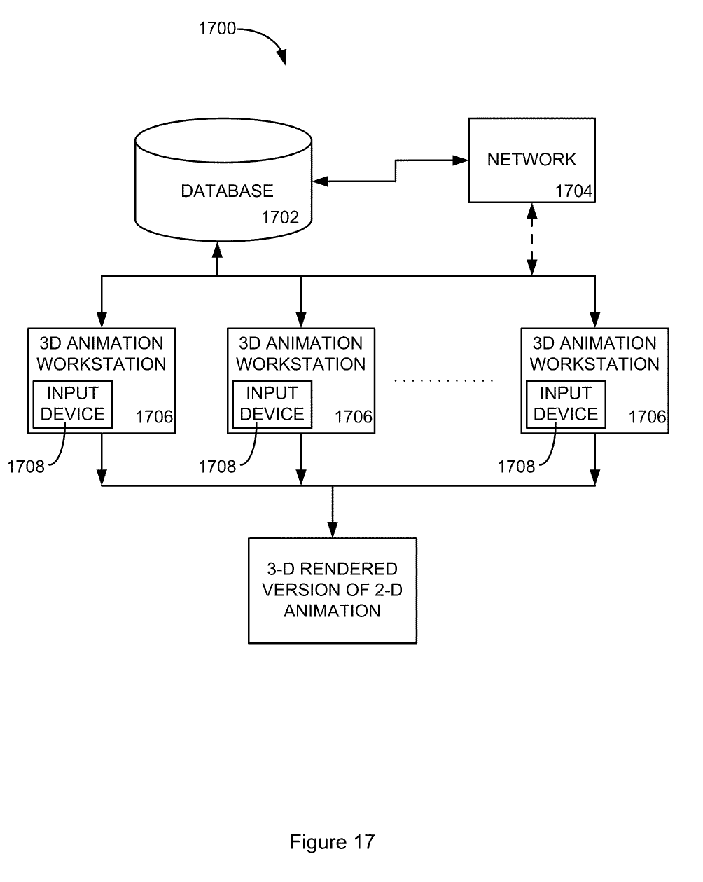

FIG. 17 is a high-level block diagram illustrating a particular system 1700 for presenting a user interface to a user that provides depth information of stereoscopic 3-D frame corresponding to a 2-D frame. The system described below may provide the user interface described in FIGS. 5-16 to a user of the system.

The system 1700 may include a database 1702 to store one or more scanned or digitally created layers for each image of the multimedia presentation. In one embodiment, the database 1702 may be sufficiently large to store the many layers of an animated feature film. Generally, however, the database 1702 may be any machine readable medium. A machine readable medium includes any mechanism for storing or transmitting information in a form (e.g., software, processing application) readable by a machine (e.g., a computer). Such media may take the form of, but is not limited to, non-volatile media and volatile media. Non-volatile media includes optical or magnetic disks. Volatile media includes dynamic memory. Common forms of machine-readable medium may include, but are not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions. Alternatively, the layers of the 2-D images may be stored on a network 1704 that is accessible by the database 1702 through a network connection. The network 1704 may comprise one or more servers, routers and databases, among other components to store the image layers and provide access to such layers. Other embodiments may remove the database from the system 1700 and extract the various layers from the 2-D image directly by utilizing the one or more computing systems.

The system 1700 may also include one or more computing systems 1706 to perform the various operations to convert the 2-D images of the multimedia presentation to stereoscopic 3-D images. Such computing systems 1706 may include workstations, personal computers, or any type of computing device, including a combination therein. Such computer systems 1706 may include several computing components, including but not limited to, one or more processors, memory components, input devices 1708 (such as a keyboard, mouse, notepad or other input device), network connections and display devices. Memory and machine-readable mediums of the computing systems 1706 may be used for storing information and instructions to be executed by the processors. Memory also may be used for storing temporary variables or other intermediate information during execution of instructions by the processors of the computing systems 1706. In addition, the computing systems 1706 may be associated with the database 1702 to access the stored image layers. In an alternate embodiment, the computing systems 1706 may also be connected to the network through a network connection to access the stored layers. The system set forth in FIG. 17 is but one possible example of a computer system that may employ or be configured in accordance with aspects of the present disclosure.

Several benefits are realized by the implementations described herein. For example, the concise format of the user interface assists an operator when reviewing patterns, depth ambiguities or depth conflicts between layers, frames or sequences of frames that may not be otherwise readily apparent. For example the depth and volume of one layer may cause portions of that layer to mistakenly appear in front of another layer. The extreme values calculations in the tool would indicate that condition for the operator's quick review and correction. As another example, an operator may review the values of adjacent frame sequences and avoid or correct any harsh stereoscopic changes that result in viewer discomfort. For example, locating a principle object in front of the screen in a shallow scene followed by locating a principle object far behind the screen in a very deep scene is usually visually jarring to the viewer and should be avoided.

In addition, the user interface is useful for interacting with the layer(s) of a stereoscopic frame in XYZ coordinate space to evaluate their virtual 3-D position. The resulting attributes could be used to directly correlate with the specifications of a theater projector and viewing screen, for example. Also, it proves useful when combining layer(s) created using X Offset with those created with Z Depth/Camera settings such as live-action or virtual computer graphics rendered in XYZ space. And in all cases, the operator may utilize X Offsets or Z Depth interchangeably to adjust depth and volume, according to their comfort level with either measurement system. Also, in any system where there is a depth map and image frame available for each layer, the resulting stereoscopic left and right eye images can be generated or visualized by underlying software using the values entered in the user interface and applied to those layer(s) as described in related patent applications. The advantage of this process would be the simplified user interface which accepts changes and reflects the affect of that change on all other stereoscopic attributes, ability to make broad revisions to a frame or frames without necessarily requiring expertise in the underlying software, and ability to make holistic changes that may be calculated across multiple frames or sequences of frames. For example, an operator could adjust an entire movie for more or less overall depth based on creative direction or the practical characteristics of the intended viewing device (theatre vs. handheld device, for example.) Also, in such a case, the tool could be made to perform calculations to adjust volume attributes and minimize the “cardboard” affect caused when layers appear flatter after a decrease in overall depth of a scene, or vice versa.

It should be noted that the flowchart of FIG. 1 is illustrative only. Alternative embodiments of the present invention may add operations, omit operations, or change the order of operations without affecting the spirit and scope of the present invention.

The foregoing merely illustrates the principles of the invention. Various modifications and alterations to the described embodiments will be apparent to those skilled in the art in view of the teachings herein. It will thus be appreciated that those skilled in the art will be able to devise numerous systems, arrangements and methods which, although not explicitly shown or described herein, embody the principles of the invention and are thus within the spirit and scope of the present invention. From the above description and drawings, it will be understood by those of ordinary skill in the art that the particular embodiments shown and described are for purposes of illustrations only and are not intended to limit the scope of the present invention. References to details of particular embodiments are not intended to limit the scope of the invention.

What is claimed is:

1. A system for visualization and editing of a stereoscopic frame comprising:
one or more computing devices in communication with a display, the computing devices coupled with a storage medium storing one or more stereoscopic images, each stereoscopic image including depth and volume information for the at least one layer of the stereoscopic image;
a visualization and editing interface stored on the storage medium and displayed on the display, the visualization interface configured to:
provide at least one depth module that provides for viewing of the depth and volume information for the layer; and
provide at least one editing control that provides for editing of the depth and volume information for the at least one layer.

2. The system of claim 1 wherein the visualization interface is further configured to:
provide a scene information module that provides an identifier of the at least one layer in the storage medium.

3. The system of claim 1 wherein the visualization interface is further configured to:
provide a virtual camera module that provides placement and camera settings information about virtual cameras associated with the at least one layer.

4. The system of claim 1 wherein the depth and volume information includes depth information for a first pixel that is nearest into the foreground of the at least one layer of the stereoscopic frame and depth information for a second pixel that is furthest into the background of the at least one layer of the stereoscopic frame.

5. The system of claim 1 wherein the depth and volume information includes a perceptual z-axis position for a first pixel that is nearest into the foreground of the at least one layer of the stereoscopic frame and a perceptual z-axis position for a second pixel that is furthest into the background of the at least one layer of the stereoscopic frame.

6. The system of claim 1 wherein the depth and volume information for the at least one layer includes:
a horizontal offset value of at least one pixel of the at least one layer relative to a corresponding pixel of a duplicate version of the at least one layer, such that the at least one layer and the duplicate layer are displayed substantially contemporaneously for stereoscopic viewing of the stereoscopic frame; and
a corresponding perceptual z-axis position of the at least one pixel in the stereoscopic image when viewed stereoscopically.

7. The system of claim 6 wherein the editing of the at least one layer is performed by the one or more computer devices and comprises:
receiving a new horizontal offset value of the at least one pixel of the at least one layer;
calculating the corresponding perceptual z-axis position value of the at least one pixel in response to the new horizontal offset value;
displaying the new horizontal offset value and the corresponding perceptual z-axis position value of the at least one pixel in response to the new horizontal offset value; and
horizontally offsetting, by the new horizontal offset value, the at least one pixel of the at least one layer relative to the corresponding pixel of the duplicate version of the at least one layer, such that the at least one layer and the duplicate layer are displayed substantially contemporaneously for stereoscopic viewing of the stereoscopic frame.

8. The system of claim 6 wherein the editing of the at least one layer is performed by the one or more computer devices and comprises:
receiving a new perceptual z-axis position of the at least one pixel of the at least one layer;
calculating the corresponding horizontal offset value of the at least one pixel in response to the new perceptual z-axis position; and
horizontally offsetting, by the calculated horizontal offset value, the at least one pixel of the at least one layer relative to the corresponding pixel of the duplicate version of the at least one layer, such that the at least one layer and the duplicate layer are displayed substantially contemporaneously for stereoscopic viewing of the stereoscopic frame.

9. A machine-readable storage medium, the machine-readable storage medium storing a machine-executable code that, when executed by a computer, causes the computer to perform the operations of:
displaying a user interface comprising at least one depth module that provides for the viewing of depth and volume information for the stereoscopic frame, the depth and volume information including at least a horizontal offset value of at least one pixel of the at least one layer relative to a corresponding pixel of a duplicate version of the at least one layer and a corresponding perceptual z-axis position of the at least one pixel in the stereoscopic image when viewed stereoscopically; and
providing for editing of the stereoscopic frame through an edit control of the user interface.

10. The machine-readable storage medium of claim 9 wherein the machine-executable code further causes the computer to perform the operations of:
displaying a scene information module that provides identification information of the stereoscopic frame.

11. The machine-readable storage medium of claim 9 wherein the machine-executable code further causes the computer to perform the operations of:
displaying a virtual camera module that provides placement information and camera settings for one or more virtual cameras associated with the stereoscopic frame.

12. The machine-readable storage medium of claim 9 wherein the stereoscopic frame comprises a plurality of stereoscopic layers and machine-executable code further causes the computer to perform the operations of:
displaying a layer depth information module that provides depth and volume information for the plurality of stereoscopic layers.

13. The machine-readable storage medium of claim 9 wherein the depth information includes a first pixel offset and perceptual z-axis position for a first pixel that is nearest into the foreground of the stereoscopic frame and a second pixel offset and perceptual z-axis position for a second pixel that is furthest into the background of the stereoscopic frame.

14. The machine-readable storage medium of claim 10 wherein the stereoscopic frame comprises a portion of a stereoscopic scene and the scene information module further provides information of the stereoscopic scene and a stereoscopic frame selection tool for selecting a portion of the stereoscopic scene.

15. The machine-readable storage medium of claim 11 wherein the information about virtual cameras associated with the stereoscopic frame includes at least a virtual position and a focal length of a plurality of virtual cameras.

16. A method for editing a stereoscopic frame comprising:
displaying a user interface comprising at least one depth module that provides for the viewing of depth and volume information of a stereoscopic frame, the depth and volume information including at least a horizontal offset value of at least one pixel of the stereoscopic frame relative to a corresponding pixel of a duplicate version of the stereoscopic frame, such that the stereoscopic frame and the duplicate stereoscopic frame are displayed substantially contemporaneously for stereoscopic viewing of the stereoscopic frame;
receiving a user input through the user interface indicating an edit to the depth and volume information; and
horizontally offsetting, in response to the user input, the at least one pixel of the stereoscopic frame relative to the corresponding pixel of the duplicate version of the stereoscopic frame.

17. The method of claim 16 further comprising:
calculating a perceptual z-axis position value that corresponds to the perceived depth position of the at least one pixel in the stereoscopic frame based on the received user input; and
displaying the z-axis position value in the user interface.

18. The method of claim 16 further comprising:
displaying a virtual camera module that provides placement information about one or more virtual cameras associated with the stereoscopic frame; and
receiving a user input through the user interface indicating an edit to the placement information about the virtual cameras.

19. The method of claim 16 wherein stereoscopic frame comprises a plurality of stereoscopic layers, the method further comprising:
calculating a horizontal offset for one or more pixels of each of the plurality of stereoscopic layers in response to a received edit to the depth and volume information for at least one of the stereoscopic layers; and
horizontally offsetting, in response to the received edit, at least one pixel for each of the plurality of stereoscopic layers of the stereoscopic frame relative to a corresponding pixel of a duplicate version of each of the plurality of stereoscopic layers of the stereoscopic frame.

20. The method of claim 15 wherein the depth information includes a first pixel offset and a perceptual z-axis position for a first pixel that is nearest into the foreground of the stereoscopic frame and a second pixel offset and a perceptual z-axis position for a second pixel that is furthest into the background of the stereoscopic frame.
